(19) United States
(12) Patent Application Publication
(10) Pub. No.: US 2023/0383040 A1
(43) Pub. Date: Nov. 30, 2023

(54) Ethylene Alkyl Acrylate-Based Copolymer Ionomer and Manufacturing Method Thereof

(71) Applicants: SK Innovation Co., Ltd., Seoul (KR); SK Geo Centric Co., Ltd., Seoul (KR)

(72) Inventors: Sang Yeup Lee, Daejeon (KR); Soon Min Kwon, Daejeon (KR); Ki Yup Kim, Daejeon (KR)

(21) Appl. No.: 18/325,461

(22) Filed: May 30, 2023

(30) Foreign Application Priority Data
May 31, 2022 (KR) 10-2022-0066579

(51) Int. Cl. C08F 265/06

(52) U.S. Cl. CPC C08F 265/06

(57) ABSTRACT

The present disclosure relates to an ethylene alkyl acrylate-based copolymer ionomer and a preparation method thereof. Specifically, the present disclosure relates to a preparation method of an ionomer including (a) preparing a mixture by mixing an ethylene-based copolymer selected from an ethylene alkyl acrylate copolymer and/or an ethylene alkyl methacrylate copolymer having a melt index of 1 to 500 g/10 min as measured according to ASTM D1238, and an alkali metal salt; and (b) melting at 100 to 400° C. and stirring the mixture to introduce a substituent of an acrylic acid salt and/or a methacrylic acid salt into the copolymer.

### CROSS-REFERENCE TO RELATED APPLICATION

This application claims priority to Korean Patent Application No. 10-2022-0066579 filed on May 31, 2022, the disclosure of which is hereby incorporated by reference in its entirety.

### BACKGROUND OF THE INVENTION

### Field of the Invention

The following disclosure relates to an ethylene alkyl acrylate-based copolymer ionomer and a preparation method thereof.

### Description of Related Art

The resin composition containing an ethylene-unsaturated carboxylic acid-based copolymer and an ionomer thereof has excellent adhesion to metal and glass, transparency, mechanical strength, resilience, etc., and therefore has been used for various purposes, including building materials such as interior and exterior materials for automobiles and floor materials, films and sheets for miscellaneous goods, etc. In addition, an ethylene-unsaturated carboxylic acid-based copolymer and an ionomer thereof are often used in combination with other components depending on the application or required physical properties.

In general, the ionomer collectively refers to a polymer containing an ionic bond structure generated through a kind of acid-base reaction between a carboxylic acid residue and a metal ion contained in the polymer. The ionomer may be prepared by copolymerization of a monomer containing a carboxylic acid group and an ethylene-based monomer, and typically, the ethylene-based copolymer containing a carboxylic acid group is polymerized through a high-pressure reactor. However, when a high-content of carboxylic acid group-containing monomers is copolymerized in the high-pressure reactor, it is difficult to increase the molecular weight of the copolymer. Further, it is difficult to control a polymerization rate due to a high content of carboxylic acid group, and side reactions may occur during polymerization due to a high reactivity of the carboxylic acid. Furthermore, there is a limit in that the content of the carboxylic acid group may not be increased beyond a certain amount due to trouble with a high-pressure compressor during high-pressure polymerization.

It is difficult to increase a content of the carboxylic acid group in the ionomer to a certain level or more by the conventional polymerization method using the high-pressure reactor, and even if a copolymer containing a high content of carboxylic acid group is polymerized, it is difficult to obtain a high molecular weight polymer and is difficult to use industrially due to high cost and low yield.

Accordingly, there is a need for research on a new preparation method of an ionomer capable of preparing the ionomer containing a high content of carboxylic acid group at a low cost and with high economic efficiency.

### Related Art Document

### Patent Document

(Patent Document 1) Korea Patent Laid-open Publication No. 10-2018-0086541 (Aug. 1, 2018)

### SUMMARY OF THE INVENTION

An embodiment of the present disclosure is directed to providing a novel ionomer preparation method for preparing a high-content carboxylic acid-based ionomer at a low cost and high efficiency. Another embodiment of the present invention is directed to providing an ionomer resin having a high weight average molecular weight while having a high content of carboxylic acid group.

In one general aspect, there is provided a preparation method of an ionomer comprising: (a) preparing a mixture by mixing an ethylene-based copolymer selected from an ethylene alkyl acrylate copolymer and/or an ethylene alkyl methacrylate copolymer having a melt index of 1 to 500 g/10 min as measured according to ASTM D1238(190° C., 2.16 kg), and an alkali metal salt; and (b) melting at 100 to 400° C. and stirring the mixture to introduce a substituent of an acrylic acid salt and/or a methacrylic acid salt into the copolymer.

The ethylene-based copolymer may have a melt index of 1 to 150 g/10 min as measured according to ASTM D1238(190° C., 2.16 kg).

The alkali metal salt may comprise a metal hydroxide or sodium hydroxide.

The ethylene-based copolymer may comprise 1.0 mol % or more of repeating units of the acrylic acid salt and/or the methacrylic acid salt.

The ethylene-based copolymer may comprise 1.5 mol % or more of repeating units of the acrylic acid salt and/or the methacrylic acid salt.

The ionomer may have a melt index (190° C., 2.16 kg) of 100 g/10 min or less.

The ionomer may have a melt index (190° C., 2.16 kg) of 1 g/10 min or less.

The ethylene alkyl acrylate copolymer may comprise an ethylene C₁-C₁₀ alkyl acrylate copolymer.

The ethylene-based copolymer may comprise 1 to 50 mol % of the alkyl acrylate repeating unit and/or the alkyl methacrylate repeating unit in the copolymer.

The ethylene-based copolymer may comprise 10 mol % or more of a second repeating unit comprising the methacrylic acid salt and/or the acrylic acid salt, based on the total of a first repeating unit comprising the alkyl methacrylate and/or the alkyl acrylate and the second repeating unit comprising the methacrylic acid salt and/or the acrylic acid salt.

In the step (b), melting and stirring may be performed in a reaction extruder.

In the step (b), a melting temperature may be 150 to 350° C.

A residence time of the reaction extruder may be 5 minutes or more.

The alkali metal hydroxide may be mixed with an alcohol-based solvent.

The ionomer be essentially free or free of acrylic acid and/or methacrylic acid.

In another general aspect, there is provided an ionomer prepared from the preparation method as described above.

Also provided is a method for reducing greenhouse gas emissions in preparing an ionomer, comprising: (a) preparing a mixture by mixing an ethylene-based copolymer selected from an ethylene alkyl acrylate copolymer and/or an ethylene alkyl methacrylate copolymer having a melt index of 1 to 500 g/10 min as measured according to ASTM D1238 (190° C., 2.16 kg), and an alkali metal salt; and (b) melting at 100 to 400° C. and stirring the mixture to introduce a substituent of an acrylic acid salt and/or a methacrylic acid salt into the copolymer.

### DESCRIPTION OF THE INVENTION

Hereinafter, an ethylene alkyl acrylate-based copolymer ionomer and a preparation method thereof according to the present disclosure will be described in detail.

Technical terms and scientific terms used herein have the general meaning understood by those skilled in the art to which the present invention pertains, unless otherwise defined, and a description for the known function and configuration unnecessarily obscuring the gist of the present disclosure will be omitted in the following description.

Singular forms used in the specification are intended to include the plural forms as well unless otherwise indicated in context. As used herein, the singular form of “a”, “an”, and “the” include plural referents unless the context clearly states otherwise.

In addition, units used herein are based on weight, unless otherwise specified. For example, the unit of % or ratio means % by weight or ratio by weight, and % by weight means % by weight of any one component in the total composition, unless otherwise defined.

For the purposes of this specification, unless otherwise indicated, all numbers expressing quantities of ingredients, reaction conditions, dimensions, physical characteristics, and so forth used in the specification and claims are to be understood as being modified in all instances by the term “about.” Unless indicated to the contrary, the numerical parameters set forth in the following specification and attached claims are approximations that can vary depending upon the desired properties sought to be obtained by the present invention.

In addition, numerical ranges used herein include a lower limit, an upper limit, and all values within that range, increments that are logically derived from the type and width of the defined range, all double-defined values, and all possible combinations of upper and lower limits of numerical ranges defined in different forms. Unless otherwise specifically defined in the specification of the present disclosure, values outside the numerical range that may arise due to experimental errors or rounded values are also included in the defined numerical range. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements

Also, it should be understood that any numerical range recited herein is intended to include all sub-ranges subsumed therein. For example, a range of “1 to 10” is intended to include any and all sub-ranges between and including the recited minimum value of 1 and the recited maximum value of 10, that is, all subranges beginning with a minimum value equal to or greater than 1 and ending with a maximum value equal to or less than 10, and all subranges in between, e.g., 1 to 6.3, or 5.5 to 10, or 2.7 to 6.1.

As used herein, the term “comprise” is an “open” description having the meaning equivalent to expressions such as “include,” “contain,” “have,” or “feature”, and does not exclude elements, materials, or process that are not further listed.

In addition, as used herein, the term “substantially” means that other elements, materials, or processes not listed with the specified element, material, or process may be present in an amount or degree that does not have an unacceptably significant effect on at least one basic and novel technical idea of the invention.

Conventional ionomers have been prepared by polymerization in a high-pressure reactor, but it was difficult to increase the content of carboxylic acid groups in the ionomer to a certain level or more, and even if a copolymer containing a high content of carboxylic acid groups is polymerized, it was difficult to obtain a high molecular weight polymer, and it was difficult to use industrially due to a high cost and a low yield.

Accordingly, the present disclosure provides a method for preparing an ionomer from a commonly used ethylene alkyl (meth)acrylate-based copolymer resin in order to solve the above problems.

The method for preparing the ionomer solves the problems, for example by designing a synthesis route which can improve process efficiency, reduce waste, and/or minimize the materials used to produce the ionomer. By reducing waste, minimizing materials used to produce the ionomer and/or improving process efficiency, the generation of waste plastic material may be reduced, thereby reducing the release of greenhouse gases such as carbon dioxide, nitrous oxide and/or methane into the environment when the waste plastic decomposes or is incinerated. By avoiding the release of greenhouse gases, the reduction of waste plastic material can reduce greenhouse gas emissions and help to mitigate climate change.

In some embodiments, the present disclosure provides a preparation method of an ionomer comprising: (a) preparing a mixture by mixing an ethylene-based copolymer selected from an ethylene alkyl acrylate copolymer and/or an ethylene alkyl methacrylate copolymer having a melt index of 1 to 500 g/10 min as measured according to ASTM D1238 (190° C., 2.16 kg), and an alkali metal hydroxide; and (b) melting at 100 to 400° C. and stirring the mixture to introduce a substituent of an acrylic acid salt and/or a methacrylic acid salt into the copolymer.

Also provided is a method for reducing greenhouse gas emissions in preparing an ionomer, comprising: (a) preparing a mixture by mixing an ethylene-based copolymer selected from an ethylene alkyl acrylate copolymer and/or an ethylene alkyl methacrylate copolymer having a melt index of 1 to 500 g/10 min as measured according to ASTM D1238(190° C., 2.16 kg), and an alkali metal salt; and (b) melting at 100 to 400° C. and stirring the mixture to introduce a substituent of an acrylic acid salt and/or a methacrylic acid salt into the copolymer.

The preparation method of an ionomer according to the present disclosure does not require preparing an ethylene-based copolymer resin containing carboxylic acid under high-pressure reaction conditions, and may thus provide an ionomer from relatively inexpensive raw materials with high economic efficiency, thereby improving process efficiency. In addition, the preparation method of an ionomer according to the present disclosure is very simple because the ionomer is prepared by simply performing the reaction at a melting temperature of the ethylene-based copolymer resin without additional additives to provide the ionomer, thereby minimizing materials required for production of the ionomer and reducing waste. In addition, it is possible to provide an ionomer containing a high content of carboxylic acid groups, which is difficult to achieve in conventional methods for preparing an ionomer, and a high molecular weight ionomer in which the content of the carboxylic acid salt may be freely adjusted.

In an embodiment of the present disclosure, the ethylene-based copolymer may have, but is not limited to, a melt index of 1 to 500 g/10 min, or 1 to 200 g/10 min, specifically, 1 to 150 g/10 min, or 1 to 100 g/10 min, or 1 to 5 g/10 min as measured according to ASTM D1238(190° C., 2.16 kg).

In an embodiment of the present disclosure, the ethylene-based copolymer may comprise, but is not limited to, 1.0 mol % or more, or 1.5 mol % or more, or 1.5 mol % to 50 mol %, or 3 mol % to 30 mol % of repeating units of an acrylic acid salt and/or a methacrylic acid salt.

The ionomer may have, but is not limited to, a melt index (190° C., 2.16 kg) of 100 g/10 min or less, or 10 g/10 min or less, or 5 g/10 min or less, or 1 g/10 min or less, or 0.01 to 1 g/10 min, or 0.3 to 0.7 g/10 min as measured according to ASTM D1238 (190° C., 2.16 kg).

In some embodiments, the ethylene alkyl acrylate copolymer comprises an ethylene C₁-C₁₀ alkyl acrylate copolymer, ethylene C₂-C₈ acrylate copolymer, ethylene C₃-C₇ acrylate copolymer, ethylene C₃-C₆ acrylate copolymer, and/or ethylene C₃-C₄ acrylate copolymer. In some embodiments, the ethylene alkyl methacrylate copolymer comprises an ethylene C₁-C₁₀ alkyl methacrylate copolymer, ethylene C₂-C₈ methacrylate copolymer, ethylene C₃-C₇ methacrylate copolymer, ethylene C₃-C₆ methacrylate copolymer, and/or ethylene C₃-C₄ methacrylate copolymer. In some embodiments, a mixture of any of the ethylene alkyl acrylate copolymer(s) and ethylene alkyl methacrylate copolymer(s) can be used. When the alkyl in the ethylene-based copolymer is C₃-C₄, the alkyl group is easily separated and the ethylene-based copolymer may be easily prepared as an ionized resin. In addition, the separated C₃-C₄ alkyl group is preferred because it may be converted to propanol or butanol and then easily vaporized and removed from the reactor because its boiling point is lower than the melting and stirring temperatures.

The ethylene alkyl acrylate copolymer and ethylene alkyl meth acrylate copolymer may be prepared by polymerizing ethylene and (meth)acrylate-based monomers. In some embodiments, the acrylic acid-based monomer(s) used to prepare the ethylene-based copolymer may be any one or a mixture of two or more selected from methyl methacrylate, methyl acrylate, ethyl acrylate, ethyl methacrylate, propyl acrylate, propyl methacrylate, butyl acrylate, butyl methacrylate, pentyl acrylate, pentyl methacrylate, cyclohexyl acrylate, cyclohexyl methacrylate, n-hexyl acrylate, and/or n-hexyl methacrylate, or any one or a mixture of two or more selected from propyl acrylate, propyl methacrylate, butyl acrylate, and butyl methacrylate, or any one or a mixture of two or more selected from butyl acrylate and butyl methacrylate.

The ethylene alkyl acrylate copolymer or ethylene alkyl meth acrylate copolymer may be polymerized by reacting the ethylene with the acrylate-based monomer(s) and/or methacrylate-based monomer(s). A method for preparing the ethylene-based copolymer may be selected without limitation as long as it is a commercial polymerization method, and the method may be, for example, bulk polymerization, suspension polymerization, solution polymerization, etc., and preferably, solution polymerization, but the present disclosure is not limited thereto.

For example, the solution polymerization may be performed by adding ethylene, an acrylate-based polymer and/or a methacrylate polymer, and a polymerization initiator to a polymerization solvent. If necessary, polymerization may be polymerized by further adding a metal oxide in the polymerization reaction. The metal oxide may act as a Lewis acid to further facilitate the polymerization, and the metal oxide may be recovered and recycled again.

As the metal oxide, alkaline earth metals, transition metals, group 13 and group 14 metal oxides, etc. can be used. Non-limiting examples of the metal oxide may comprise or be, but are not limited to, at least one selected from the group consisting of aluminum oxide (Al₂O₃), yttrium oxide (Y₂O₃), zinc oxide (ZnO₂), hafmium oxide (HfO₂), silicon oxide (SiO₂), boron oxide (B₂O₃), cesium oxide (CeO₂), dysprosium oxide (Dy₂O₃), erbium oxide (Er₂O₃), europium oxide (Eu₂O₃), gadolinium oxide (Gd₂O₃), holmium oxide (Ho₂O₃), lanthanum oxide (La₂O₃), lutetium oxide (Lu₂O₃), neodymium oxide (Nd₂O₃), praseodymium oxide (Pr₆O₁₁), samarium oxide (Sm₂O₃), terbium oxide (Tb₂O₃), thorium oxide (Th₄O₇), thulium oxide (Tm₂O₃), ytterbium oxide (Yb₂O₃), tin oxide (SnO), titanium oxide (TiO₂), dysprosium aluminate (Dy₃Al₅O₁₂), yttnium aluminate (Y₃Al₅O₁₂), aluminum titanate (Al₂O₃·TiO₂), aluminum silicate (3Al₂O₃·2SiO₂), calcium titanate (CaTiO₃), calcium zirconate (CaZrO₃), iron titanate (FeTiO₃), magnesium aluminate (MgO·Al₂O₃), cesium aluminate (CeAl₁₁O₁₈), aluminum sulfate (Al₂ (SO₄)₃), aluminum phosphate (AlPO₄) and mixtures thereof.

The metal oxide may be used, but is not limited to, in a molar ratio of 0.1 to 10, or 0.1 to 1 based on 1 mole of the acrylate-based comonomer.

As the polymerization solvent, aromatic solvents, aliphatic solvents, ether-based solvents, halogenated alkyl solvents, etc., may be used without limitation. Examples of the polymerization solvent may comprise, but are not limited to, one or more solvents or a mixture solvents selected from the group consisting of toluene, chlorobenzene, n-hexane, n-heptane, tetrahydrofuran, chloroform, methylene chloride and mixtures thereof. The polymerization solvent may be used, but is not limited to, in an amount of 300 to 5,000 parts by weight, or 1,500 to 2,500 parts by weight based on 100 parts by weight of the acrylate-based comonomer.

As the polymerization initiator, a known radical polymerization initiator may be used without limitation. Examples of polymerization initiators may comprise, but are not limited to, peroxides, azo compounds, or mixtures thereof. The polymerization initiator may be used, but is not limited to, in a molar ratio of 0.001 to 1.0, or 0.01 to 0.1 based on 1 mole of the acrylic acid-based comonomer.

The polymerization may be performed, but is not limited to, at a pressure of 1 to 200 atm and a temperature of 30 to 150° C., or at a pressure of 1 to 5 atm and a temperature of 50 to 120° C.

According to an embodiment of the present disclosure, the ethylene alkyl acrylate copolymer or the ethylene alkyl methacrylate copolymer may have, but is not limited to, a weight average molecular weight of 100,000 to 5,000,000 g/mol, specifically 150,000 to 3,000,000 g/mol, or 200,000 to 2,000,000 g/mol, or 300,000 to 1,000,000 g/mol.

An ionomer may be prepared by adding an alkali metal salt to the ethylene-based copolymer, and melting and stirring the resulting mixture. The alkyl methacrylate group(s) and/or alkyl acrylate group(s) of the ethylene-based copolymer may be substituted to provide a methacrylic acid salt group(s) and/or an acrylic acid salt group(s) by reacting with the alkali metal salt, such as metal hydroxide(s), in a high-temperature molten state.

The alkali metal salt may be, but is not limited to, any one alkali metal salt selected from alkali metal hydroxide and/or alkali metal carbonate, and may specifically be alkali metal hydroxide.

In an embodiment of the present disclosure, the alkali metal hydroxide may be, for example, potassium hydroxide, sodium hydroxide, and/or lithium hydroxide, etc., or sodium hydroxide. The sodium hydroxide has a relatively low melting temperature, so that the mixture may be melted and mixed very uniformly during melting and stirring, and accordingly, the content of the acrylic acid salt or methacrylic acid salt of the ionomer may be increased.

Non-limiting examples of the alkali metal carbonate comprise lithium carbonate, sodium carbonate and/or potassium carbonate.

In an embodiment of the present disclosure, the ethylene-based copolymer may comprise, but is not limited to, 10 to 90 mol %, or 10 to 70 mol % and, or 10 to 50 mol % of the alkyl acrylate repeating unit and/or the alkyl methacrylate repeating unit in the copolymer.

In an embodiment of the present disclosure, the ethylene-based copolymer may comprise 10 mol % or more, or 10 mol % to 100 mol %, or 10 mol % to 50 mol % of a second repeating unit comprising the methacrylic acid salt (s) and/or the acrylic acid salt(s), based on the sum of a first repeating unit comprising the alkyl methacrylate(s) and/or the alkyl acrylate(s) and the second repeating unit comprising the methacrylic acid salt(s) and the acrylic acid salt(s). As the second repeating unit corresponding to the carboxylic acid salt in the ionomer is comprised in less than 100 mol %, for example 10 mol % to 50 mol % based on the sum of the first and second repeating units, the ionomer may be preferable in that it may have relatively low hardness properties that are difficult to achieve in conventional ethylene-acrylic acid-based ionomers.

Meanwhile, since the degree of substitution of alkyl methacrylate and/or alkyl acrylate with a methacrylic acid salt and/or an acrylic acid salt is proportional to an amount of alkali metal salt added, the mol % of the second repeating unit may be easily controlled according to the amount of alkali metal salt added. That is, as the amount of alkali metal salt added increases, the amount of substitution of the alkyl methacrylate and/or the alkyl acrylate with the methacrylic acid salt and/or the acrylic acid salt increases. Thus, the preparation method of an ionomer according to the present disclosure has the advantage of easily providing an ionomer containing a desired amount of methacrylic acid salt and/or acrylic acid salt.

In an embodiment of the present disclosure, in the step (b), melting and stirring may be performed in a reaction extruder.

In addition, in an embodiment of the present disclosure, in the step (b), the melting temperature may be, but is not limited to, 120 to 350° C., or 150 to 300° C., or 180 to 250° C.

In particular, in the temperature range of 180 to 250° C., yellowing due to the ionomer reaction may be suppressed without thermal decomposition of the ethylene-based copolymer.

In an embodiment of the present disclosure, the residence time of the reaction extruder may be, but is not limited to, 5 minutes or more, or 5 minutes to 30 minutes, or 10 minutes to 20 minutes.

In addition, it may be provided by adding it in the form of a master batch during the melting, but the present disclosure is not limited thereto. As it is added in the form of the master batch, it may be mixed very uniformly.

In an embodiment of the present disclosure, the alkali metal salt may be a mixed solution mixed with an alcohol-based solvent.

Rather than directly adding the alkali metal salt in a powder state, the ethylene-based copolymer and the alkali metal salt may be more uniformly mixed by mixing a mixed solution dissolved in an alcohol-based solvent with the ethylene-based copolymer. The alcohol-based solvent is not limited thereto, but may be, for example, a glycol-based compound, or any one or two or more alcohol-based solvents selected from ethylene glycol, diethylene glycol, triethylene glycol, 1,2-propylene glycol, 1,3-propylene glycol, dipropylene glycol, and/or butylene glycol.

Also, the alkali metal hydroxide of the mixed solution may be mixed at a concentration of 50 wt % or less, or 10 wt % to 40 wt %, or 20 wt % to 30 wt %, but the present disclosure is not limited thereto.

The present disclosure provides an ionomer prepared from the above preparation method.

The ionomer may have a weight average molecular weight of, but is not limited to, 10,000 to 5,000,000 g/mol, or 20,000 to 3,000,000 g/mol, or 30,000 to 2,000,000 g/mol, or 50,000 to 1,000,000 g/mol.

According to the present disclosure, by using the commercially available ethylene-based copolymer instead of the acrylic acid-based copolymer, a preparation cost of an ionomer is significantly reduced, and ionomers of various grades may be provided without being limited by weight average molecular weight or melt index, and thus ionomers having desired processability, excellent mechanical properties, etc. may be provided.

In some embodiments, the ionomer according to the present disclosure is is essentially free or free of acrylic acid and/or methacrylic acid, for example the ionomer comprises less than 5 weight percent, or less than 4 weight percent, or less than 3 weight percent, or less than 2 weight percent, or less than 1 weight percent, or less than 0.5 weight percent, or less than 0.1 weight percent, or less than 0.05, or less than 0.01 weight percent, or is free of acrylic acid and/or methacrylic acid. In some embodiments, the ionomer has a lower hardness compared to conventional ionomers containing acrylic acid or methacrylic acid. Acrylic acid and/or methacrylic acid induces a hydrogen bond to give the ionomer high hardness, but the ionomer according to the present invention is essentially free or free of acrylic acid and/or methacrylic acid, and thus may have a unique low hardness.

In addition, an ionomer according to the present disclosure has a small agglomeration effect of metal ions and acrylate, thereby having an excellent adhesive effect when used as an adhesive.

The ionomer according to the present disclosure may preferably be included as a material for a multi-layered golf ball structure. For example, the multi-layer golf ball may include a cover layer, an intermediate layer, and a core layer, and the ionomer may be comprised as a material for an intermediate layer. The ionomer according to the present disclosure has lower hardness and superior adhesiveness than the acrylic acid-based ionomer prepared from a conventional high-pressure reactor, and thus may impart excellent durability to a golf ball even against physical impact. Other non-limiting examples of applications for the ionomer may comprise coatings, adhesives, impact modification and thermoplastics.

Hereinafter, the present disclosure will be described in more detail on the basis of Examples and Comparative Examples. However, the following Examples and Comparative Examples are only examples for describing the present disclosure in more detail, and the present disclosure is not limited by the following Examples and Comparative Examples.

[Physical Properties Measurement]

1. Melt Index Measurement

It was measured according to an ASTM D1238 (190° C., 2.16 kg) standard measurement method.

2. Acrylate Content and Ionomer Content Measurement

The acrylate content and the ionomer content were measured using ¹³C-NMR and FT-IR.

3. Shore Hardness Measurement

It was measured according to an ASTM D2240 standard measurement method. Shore hardness is measured using Shore D hardness tester by overlapping five 4 cm×4 cm sheets with a thickness of 1 mm stored in a 20° C. thermostat for 1 hour or more. When a surface is pressed with a needle of the hardness tester, a hardness value of a gauge reaches a maximum value and then decreases and stabilizes. At this time, the maximum value was set as a hardness value.

### Example 1

0.63 g of sodium hydroxide (NaOH, Aldrich) per 100 g of ethylene butyl acrylate copolymer resin (melting index (190° C., 2.16 kg) 40 g/10 min, butyl acrylate content: 10.5 mol %, SKFP Lotryl 35BA40) was added to a twin-screw reaction extruder and melt-extruded at 180° C. at 300 rpm. Butyl alcohol generated during the reaction was removed through a vacuum suction device installed at a rear end of the extruder. The extruded molten polymer strand was cooled in a cooling water bath, transferred to a pelletizer, cut and made into a uniform pellet.

### Example 2

1.7 g of sodium hydroxide (NaOH, Aldrich) per 100 g of ethylene butyl acrylate copolymer resin (melting index (190° C., 2.16 kg) 40 g/10 min, butyl acrylate content: 10.5 mol %, SKFP Lotryl 35BA40) was added to a twin-screw reaction extruder and melt-extruded at 180° C. at 300 rpm.

### Example 3

Example 3 was carried out in the same manner as in Example 2, except that melt extrusion was performed by adding 100 g of propylene glycol in which sodium hydroxide was dissolved at a concentration of 16 wt % instead of sodium hydroxide.

### Comparative Example 1

0.67 g of sodium hydroxide (NaOH, Aldrich) per 100 g of acrylic acid copolymer resin (melting index (190° C., 2.16 kg) 250 g/10 min, 9.1 mol % of acrylic acid) was added to a twin-screw reaction extruder and melt-extruded at 180° C. at 300 rpm. Moisture generated during the reaction was removed through a vacuum suction device installed at the rear end of the extruder. The extruded molten polymer strand was cooled in a cooling water bath, transferred to a pelletizer, cut and made into a uniform pellet.

### Comparative Example 2

0.91 g of sodium hydroxide (NaOH, Aldrich) per 100 g of acrylic acid copolymer resin (melting index (190° C., 2.16 kg) 60 g/10 min, 5.7 mol % of acrylic acid) was added to a twin-screw reaction extruder and melt-extruded at 180° C. at 300 rpm. Moisture generated during the reaction was removed through a vacuum suction device installed at the rear end of the extruder. The extruded molten polymer strand was cooled in a cooling water bath, transferred to a pelletizer, cut and made into a uniform pellet.

TABLE 1

| | | | | Acrylic acid | | |
|---|---|---|---|---|---|---|
| | Melt index | Acrylate | | salt content | | |
| | of ionomer | repeat unit | | of ionomer | | Hardness |
| | (g/10 min) | (mol %) | | (mol %) | | [shore D] |
| Example 1 | 0.6 | 10.5 | mol % | 1.57 | mol % | — |
| Example 2 | Not | 10.5 | mol % | 4.2 | mol % | 35 |
| | measurable | | | | | |
| Example 3 | Not | 10.5 | mol % | 9 | mol % | |
| | measurable | | | | | |
| Comp. | 49 | 9.1 | mol % | 1.68 | mol % | — |
| Example 1 | | | | | | |
| Comp. | 2.4 | 5.7 | mol % | 2.28 | mol % | 66 |
| Example 2 | | | | | | |

As shown in Table 1, ethylene butyl acrylate copolymers or ionomers derived from ethylene butyl acrylate copolymers were prepared through the ionomer preparation method of the present disclosure.

The ionomer according to the examples is an ionomer that does not contain acrylic acid, which cannot be conventionally prepared, and accordingly, an ionomer with a lower hardness than an ionomer containing conventional acrylic acid or methacrylic acid may be prepared.

Specifically, from the hardness of Example 2 and Comparative Example 2 it is confirmed that the hardness of Comparative Example 2 is 1.8 times higher than that of Example 2.

According to the present disclosure, an ionomer resin may be provided by a simple process using a low-cost, general-purpose acrylic acid-based copolymer.

In addition, according to the present disclosure, it is possible to provide an ionomer containing a high content of carboxylic acid group, which is difficult to achieve in conventional methods for preparing an ionomer, and a high molecular weight ionomer in which the content of the carboxylic acid group may be freely adjusted.

In addition, according to the present disclosure, it is possible to easily provide an ionomer having ductility and excellent mechanical properties.

Hereinabove, although the present disclosure has been described by specific matters, the limited embodiments, and Comparative Examples, they have been provided only for assisting in a more general understanding of the present disclosure.

Therefore, the present disclosure is not limited to the exemplary embodiments. Various modifications and changes may be made by those skilled in the art to which the present disclosure pertains from this description.

Therefore, the spirit of the present disclosure should not be limited to the above-mentioned embodiments, but the claims and all of the modifications equal or equivalent to the claims are intended to fall within the scope and spirit of the present disclosure.

What is claimed is:

1. A preparation method of an ionomer, comprising:
(a) preparing a mixture by mixing an ethylene-based copolymer selected from an ethylene alkyl acrylate copolymer and/or an ethylene alkyl methacrylate copolymer having a melt index of 1 to 500 g/10 min as measured according to ASTM D1238(190° C., 2.16 kg), and an alkali metal salt; and
(b) melting at 100 to 400° C. and stirring the mixture to introduce a substituent of an acrylic acid salt and/or a methacrylic acid salt into the copolymer.

2. The preparation method of an ionomer of claim 1, wherein ethylene-based copolymer has a melt index of 1 to 150 g/10 min as measured according to ASTM D1238 (190° C., 2.16 kg).

3. The preparation method of an ionomer of claim 1, wherein the alkali metal salt comprises a metal hydroxide.

4. The preparation method of an ionomer of claim 1, wherein the alkali metal salt is sodium hydroxide.

5. The preparation method of an ionomer of claim 1, wherein the ethylene-based copolymer comprises 1.0 mol % or more of repeating units of the acrylic acid salt and/or the methacrylic acid salt.

6. The preparation method of an ionomer of claim 5, wherein the ethylene-based copolymer comprises 1.5 mol % or more of repeating units of the acrylic acid salt and/or the methacrylic acid salt.

7. The preparation method of an ionomer of claim 1, wherein the ionomer has a melt index (190° C., 2.16 kg) of 100 g/10 min or less.

8. The preparation method of an ionomer of claim 1, wherein the ionomer has a melt index (190° C., 2.16 kg) of 1 g/10 min or less.

9. The preparation method of an ionomer of claim 1, wherein the ethylene alkyl acrylate copolymer comprises an ethylene C₁-C₁₀ alkyl acrylate copolymer.

10. The preparation method of an ionomer of claim 1, wherein the the ethylene alkyl methacrylate copolymer comprises an ethylene C₁-C₁₀ alkyl methacrylate copolymer.

11. The preparation method of an ionomer of claim 1, wherein the ethylene-based copolymer comprises 1 to 50 mol % of the alkyl acrylate repeating unit and/or the alkyl methacrylate repeating unit.

12. The preparation method of an ionomer of claim 1, wherein the ethylene-based copolymer comprises 10 mol % or more of a second repeating unit comprising the methacrylic acid salt and/or the acrylic acid salt, based on the total of a first repeating unit comprising the alkyl methacrylate and/or the alkyl acrylate and the second repeating unit comprising the methacrylic acid salt and/or the acrylic acid salt.

13. The preparation method of an ionomer of claim 1, wherein in step (b), melting and stirring are performed in a reaction extruder.

14. The preparation method of an ionomer of claim 8, wherein in step (b), a melting temperature is 150 to 350° C.

15. The preparation method of an ionomer of claim 8, wherein a residence time of the reaction extruder is 5 minutes or more.

16. The preparation method of an ionomer of claim 1, wherein the alkali metal hydroxide is mixed with an alcohol-based solvent.

17. The preparation method of an ionomer of claim 1, wherein the ionomer is essentially free or free of acrylic acid and/or methacrylic acid.

18. An ionomer prepared by the preparation method of claim 1.

19. A method for reducing greenhouse gas emissions in preparing an ionomer, comprising:
(a) preparing a mixture by mixing an ethylene-based copolymer selected from an ethylene alkyl acrylate copolymer and/or an ethylene alkyl methacrylate copolymer having a melt index of 1 to 500 g/10 min as measured according to ASTM D1238(190° C., 2.16 kg), and an alkali metal salt; and
(b) melting at 100 to 400° C. and stirring the mixture to introduce a substituent of an acrylic acid salt and/or a methacrylic acid salt into the copolymer.
